(19) United States
(12) Patent Application Publication
(10) Pub. No.: US 2009/0051074 A1
(43) Pub. Date: Feb. 26, 2009

(54) Lubricated bridge

(75) Inventors: Donald A. Roberts, Uhrichsville, OH (US); James J. Zwick, Minerva, OH (US)

Correspondence Address: SAND & SEBOLT, AEGIS TOWER, SUITE 1100, 4940 MUNSON STREET, NW, CANTON, OH, 44718-3615, US

(73) Assignee: REYMOND PRODUCTS INTERNATIONAL, INC., Midvale, OH (US)

(21) Appl. No.: 11/894,972

(22) Filed: Aug. 22, 2007

(51) Int. Cl. B29C 47/16; B28B 3/26

(52) U.S. Cl. 264/177.16; 425/466

(57) ABSTRACT

An apparatus and method provide for the extrusion of green brick material around a hole-generating member and the use of a lubrication fluid between the hole-generating member and the green brick material to reduce friction therebetween during extrusion, thus enabling the formation of larger sized holes in the bricks formed thereby.

### BACKGROUND OF THE INVENTION

1. Technical Field

The invention is related generally to the formation of extruded bricks. More particularly, the invention is related to an apparatus and method of forming holes in the bricks. Specifically, the invention is related to a lubricated hole forming structure for generating these holes.

2. Background Information

In the brick industry, it is well known to form bricks by the process of extrusion. In addition, it is known to use a bridge with core members mounted thereon within the extrusion passage in order to form or generate holes in the extruded green brick. The formation of these voids or holes allows the formation of bricks using less material. There is currently a demand to further reduce the amount of material used in forming the brick by increasing the voids or holes in the brick. Such an increase in the size of the holes reduces the thickness of the extrusion material, known as webs in the art, around the hole. The increase in the size of the core members used in forming the holes likewise simultaneously increases the amount of friction between the core members and the extruding material. Applicant's invention addresses this and other problems in the art.

### BRIEF SUMMARY OF THE INVENTION

The present invention provides an apparatus for use in generating a hole in extruded green brick material during extrusion thereof, the apparatus comprising: a hole-generating assembly for generating the hole in the extruded green brick material; a downstream end on the assembly; a first lubricant through passage formed in the assembly adapted for moving a lubricant therethrough; and an exit opening of the lubricant passage on the assembly upstream of its downstream end.

The present invention also provides an apparatus for use in generating a hole in extruded green brick material during extrusion thereof, the apparatus comprising: a bridge ring; an extrusion passage formed through the bridge ring; a bridge mounted on the bridge ring and extending across the passage; a hole-generating assembly mounted on the bridge and extending downstream therefrom for generating the hole in the extruded green brick material; and a lubricant conduit extending from the bridge ring to the bridge.

The present invention further provides a method comprising the steps of: extruding green brick material through an extrusion passage; forcing the green brick material around a hole-generating member disposed in the passage; and moving a lubrication fluid between the hole-generating member and the green brick material to reduce friction therebetween.

### BRIEF DESCRIPTION OF THE SEVERAL VIEWS OF THE DRAWINGS

FIG. 1 is a perspective view of the die assembly of the present invention in use with a brick extruder.

FIG. 2 is a diagrammatic view showing the relationship between FIGS. 2A and 2B.

FIG. 2A is an exploded perspective view of the outer portions of the die assembly.

FIG. 2B is an exploded perspective view of the inner portions of the die assembly including the lubricating bridge.

FIG. 3 is an enlarged exploded perspective view of the lubricating bridge.

FIG. 4 is an enlarged perspective view of the assembled bridge.

FIG. 5 is a sectional view of the die assembly mounted on the extruder.

FIG. 6 is a sectional view taken on line 6-6 of FIG. 5.

FIG. 7 is similar to FIG. 6 and shows the bridge having moved upwardly and the tubing having flexed to accommodate this movement of the bridge.

FIG. 8 is a sectional view through the bridge and a portion of one of the hole generating assemblies showing a portion of one of the lubricating passages.

FIG. 9 is an enlarged sectional view similar to FIG. 5 showing the flow of extruded green brick material through the die assembly with lubricant flowing through one of the lubricating passages and around one of the core members to provide lubrication between the core member and the extruded green brick material.

FIG. 10 is a perspective view of a brick formed by the method and apparatus of the present invention.

### DETAILED DESCRIPTION OF THE INVENTION

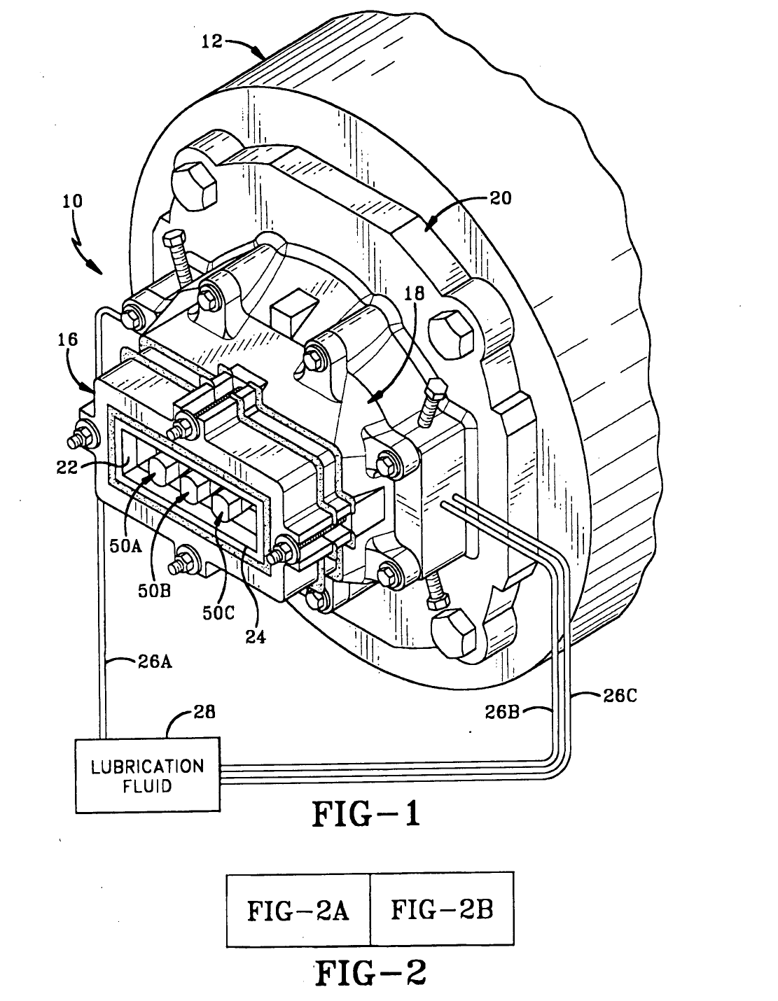

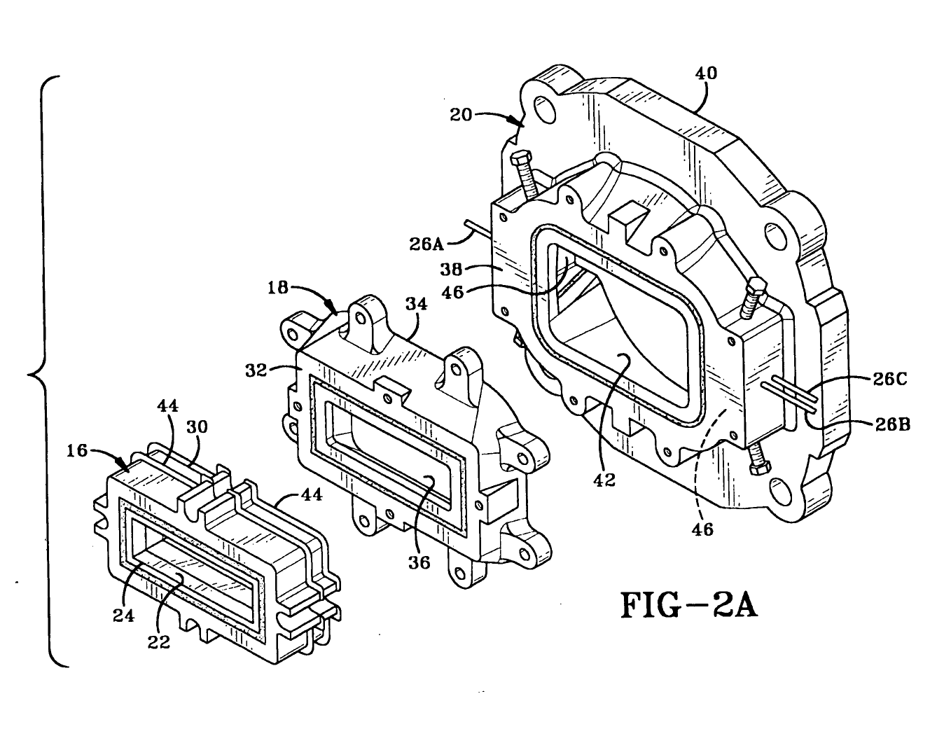

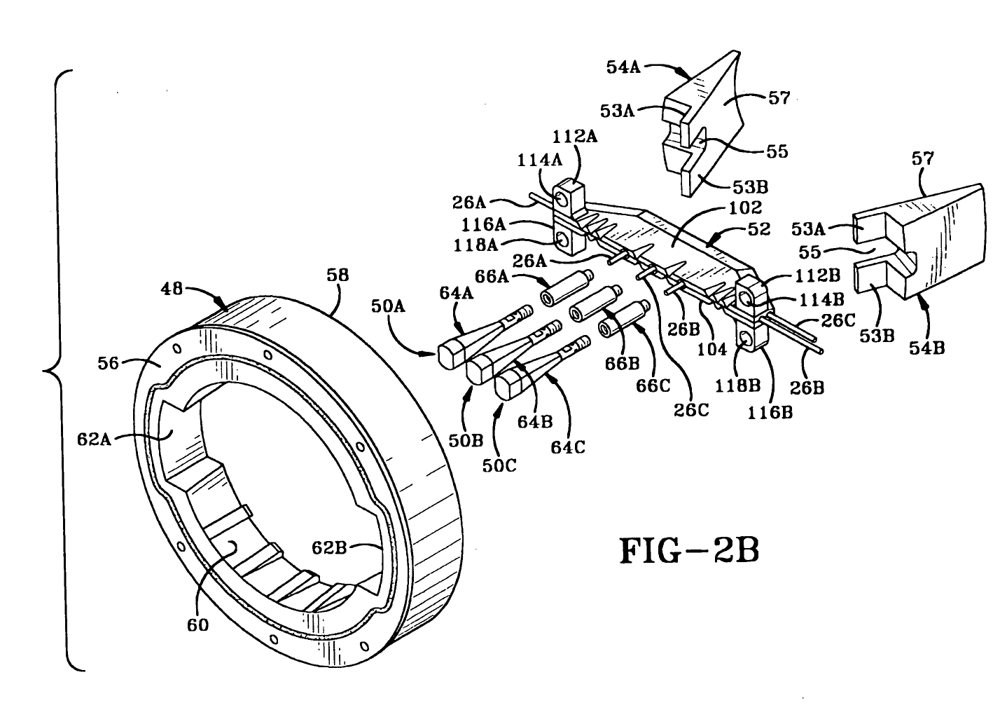

The die assembly of the present invention is shown generally at 10 in FIGS. 1, 2A and 2B. Die assembly 10 is shown mounted on the downstream end of an extruder housing of an extruder which utilizes an internal helical screw (not shown) well known in the art in the extrusion formation of green bricks which are subsequently fired to form bricks, such as that shown at 14 in FIG. 10, which are commonly used in construction. Die assembly 10 defines an extrusion passage in communication with the extrusion passage of extruder housing 12.

Referring to FIG. 1, die assembly 10 includes a die 16, an intermediate or central ring section 18 and a bridge ring 20 each of which circumscribes and bounds a portion of the extrusion passage of die assembly 10. Die 16, central section 18 and bridge ring 20 are connected to one another via a plurality of fasteners in the form of screws or bolts, nuts and washers or the like. Bridge ring 20 is likewise secured to extruder housing 12 by plurality of threaded bolts. Die 16 defines therethrough a throat 22 of the extrusion passage having an exit end or opening 24 which serves as the exit opening of the extrusion passage. In accordance with the invention, three lubricating conduits 26A-C extend outwardly from the annular outer wall of bridge ring 20 and communicate with a source 28 of lubrication fluid. This lubrication fluid can be any suitable fluid and is most typically an oil. Conduits 26 may be formed of any suitable material such as metal although in one preferred embodiment they are formed of a flexible material such as nylon or a suitable elastomeric or plastic material for purposes discussed further below.

Referring to FIG. 2A, die 16 has an upstream end 30. Throat 22 of the extrusion passage extends from downstream exit end 24 to upstream end 30. Central section 18 has downstream and upstream ends 32 and 34 defining therebetween a central section 36 of the extrusion passage. Likewise, bridge ring 20 has downstream and upstream ends 38 and 40 defining therebetween an upstream section 42 of the extrusion passage which is formed within die assembly 10. Downstream end 32 of central section 18 abuts upstream end 30 of die 16 or is disposed closely adjacent thereto with a gasket 44 disposed therebetween. Similarly, upstream end 34 abuts or is disposed closely adjacent downstream end 38 of bridge ring 20 when assembled and may have a gasket (not shown) sandwiched therebetween. Upstream end 40 either abuts or is closely adjacent the downstream end of extruder 12 when mounted thereon. Upstream section 42 includes a pair of opposed generally rectangular channels 46 which extend downstream from upstream end 40.

The internal structure of die assembly 10 includes an oil ring 48, three hole-generating assemblies 50A-C, a lubricating bridge 52 and a pair of bridge end filler members 54A-B. Oil ring 48 has downstream and upstream ends 56 and 58 and defines a section 60 of the extrusion passage extending therebetween and including opposed channels 62A-B which align respectively with channels 46 of bridge ring 20. When assembled, filler members 54A and B are disposed respectively in channels 62A and B and respectively in channels 46. Each bridge and filler member 54 is a generally wedged shape member having a narrower upstream end which tapers laterally outwardly in the downstream direction to form the wedge shape. Each member 54 includes upper and lower fingers 53A and 53B defining therebetween a notch 55. Each member 54 has an inner diverting surface 57 which diverts extruding material around the ends of bridge 52. Hole generating assemblies 50 include respective core members 64A-C and connecting pipes 66A-C.

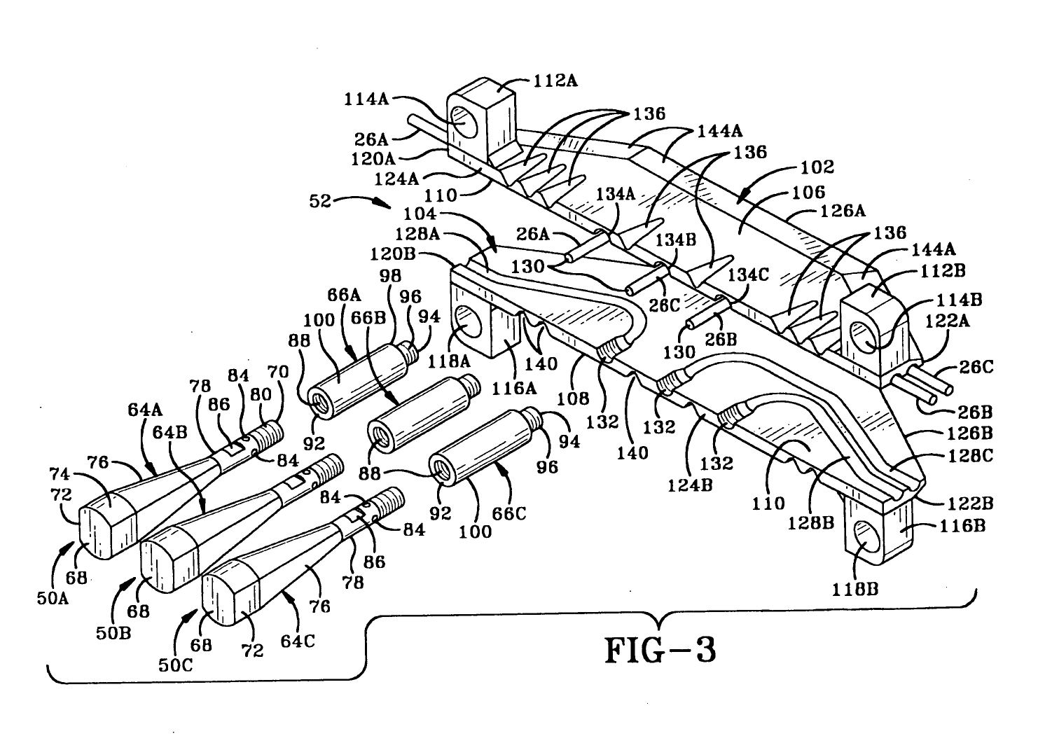

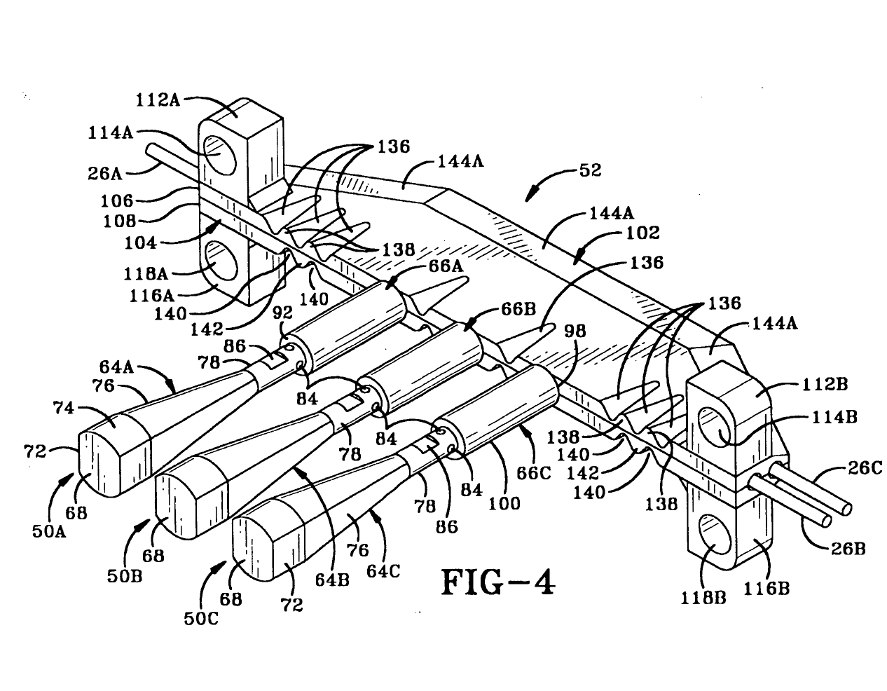

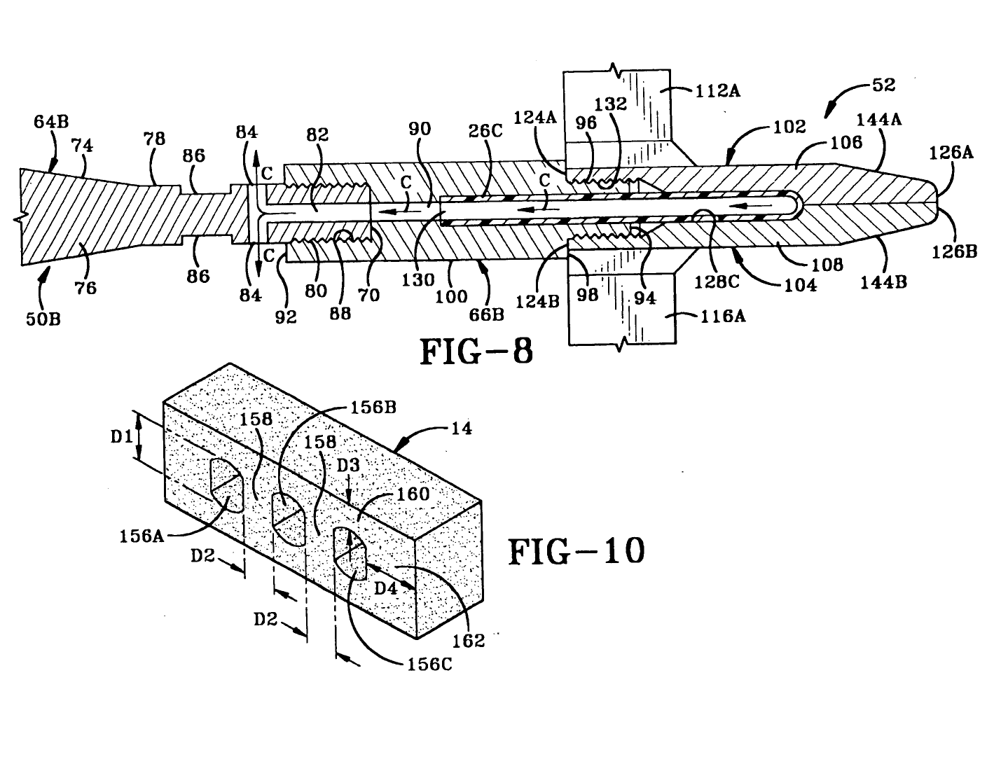

Referring to FIGS. 3 and 4, hole generating assemblies 50A-C and bridge 52 are described in further detail. Each core member 64 has downstream and upstream ends 68 and 70 between which the core member is elongated in a direction generally parallel to the flow of the green brick material during an extrusion operation. Each core member 64 includes a head 72 adjacent downstream end 68 which includes an outer surface 74 which is the outermost surface of the respective core member 64 and which defines the cross-sectional shape of the holes formed in the bricks. A tapered section 76 tapers inwardly in the upstream direction from head 72 to a neck 78 having a substantially smaller cross-sectional width or diameter than that of head 72. Neck 78 includes a hollow externally threaded portion 80 adjacent upstream end 70 defining a passage 82 (FIG. 8) which extends downstream from end 70 and branches outwardly to exit openings 84 formed on the outer surface of neck 78. A pair of flats 86 are formed on opposed sides of neck 78 downstream of openings 84 which may be engaged by a wrench or the like for threading threaded section 80 into an internally threaded portion 88 of a respective connecting pipe 66. Threaded portion 88 bounds an enlarged portion of a passage 90 formed in pipe 66 which extends from a downstream end 92 to an upstream end 94 thereof. Each pipe 66 includes an externally threaded portion 96 adjacent upstream end 94 which steps outwardly at an annular ledge 98 to a main section 100 which extends downstream from ledge 98 to downstream end 92 and is substantially cylindrical. When core members 64 are mounted on connecting pipes 66, downstream end 92 of each pipe 66 steps inwardly to neck 78 so that exit openings 84 are disposed downstream of and adjacent end 92 of pipe 66.

With continued reference to FIGS. 3 and 4, bridge 52 includes upper and lower members 102 and 104. Members 102 and 104 are substantially mirror images of one another with some variations. Members 102 and 104 are typically welded together to form bridge 52 as shown in FIG. 4. Upper member 102 includes a substantially flat upper plate 106 while lower member 104 likewise includes a substantially flat lower plate 108. Plates 106 and 108 have respective flat mating surfaces 110 which are parallel to one another and of a mating configuration so that they abut one another when plates 106 and 108 are secured to one another. A pair of upper mounts 112A-B extend upwardly from opposed ends of upper plate 106 and define respective mounting holes 114A and B. Likewise, lower mounts 116A-B extend downwardly from opposed ends of lower plate 108 and define respective mounting holes 118A-B. Upper and lower mounts 112A and 116A are mounted respectively adjacent first lateral ends 120A and 120B of plates 106 and 108. Likewise, upper and lower mounts 112B and 116B are mounted adjacent second lateral ends 122A-B of plates 106 and 108. Plates 106 and 108 have respective downstream ends 124A and B and upstream ends 126A and B.

Referring to FIG. 3 and accordance with the invention, three grooves 128A-C are formed in lower plate 108 which extend downwardly from surface 110 thereof. Grooves 128A-C respectively receive therein portions of conduits or tubes 26A-C so that respective exit ends 130 of conduits 26 are disposed downstream of downstream ends 124A and B of plates 106 and 108. Each groove 128 may include straight sections and arcuate transitioning portions which facilitate the insertion of flexible conduits 26 therethrough after plates 106 and 108 have been joined together. Groove 128A extends inwardly from lateral end 120B of plate 108 and around to downstream end 124B. Each of grooves 128B and 128C extend inwardly from lateral end 122B and extend around to downstream end 124B. Each groove 128 includes an enlarged internally threaded portion 132 which terminates at the downstream end 124B for threadedly receiving therein respective threaded portions 96 of pipes 66. Alternately, threaded portions 96 and 132 may be non-threaded and joined to plates 106 and 108 by welding or the like. Upper plate 106 includes grooves 134A-C which are respectively mirror images of grooves 128A-C although they are not shown in their entirety in the figures. Thus, when plates 106 and 108 are welded together, grooves 128A and 134A cooperate to form a through passage. This is likewise true of the combination of grooves 128B and 134B as well as the combination of grooves 128C and 134C. Conduits 26A-C are respectively disposed within these passages and extend outwardly from the respective lateral ends 120B or 122B through holes formed in bridge ring 20 and outwardly thereof to source 28 of lubricating fluid (FIG. 1). Thus, a lubricant passage extends from source 28 via conduits 26, through pipes 66 into the upstream ends of core members 64 to the outer surfaces of core members 64 via exit openings 84.

In the exemplary embodiment, two pieces of the bridge will typically be welded together to form the passages via the complementary grooves in each of the pieces. Then, ends 130 of conduits 26 will be inserted into the upstream ends of pipes 66. Subsequently, the other end of conduits 26 will be inserted into the downstream ends of the passages formed in the bridge and forced through the circuitous passages and out the openings along the lateral ends 120 and 122, then through holes formed in the bridge ring so that they may be connected to source 28 of lubrication fluid. Alternately, especially when pipes 66 are welded to the downstream end of the bridge, ends 130 of conduits 26 will subsequently be inserted through the openings on lateral ends 120 and 122 into the passages in the bridge and forced through said passages so that ends 130 move into the upstream ends of pipe 66.

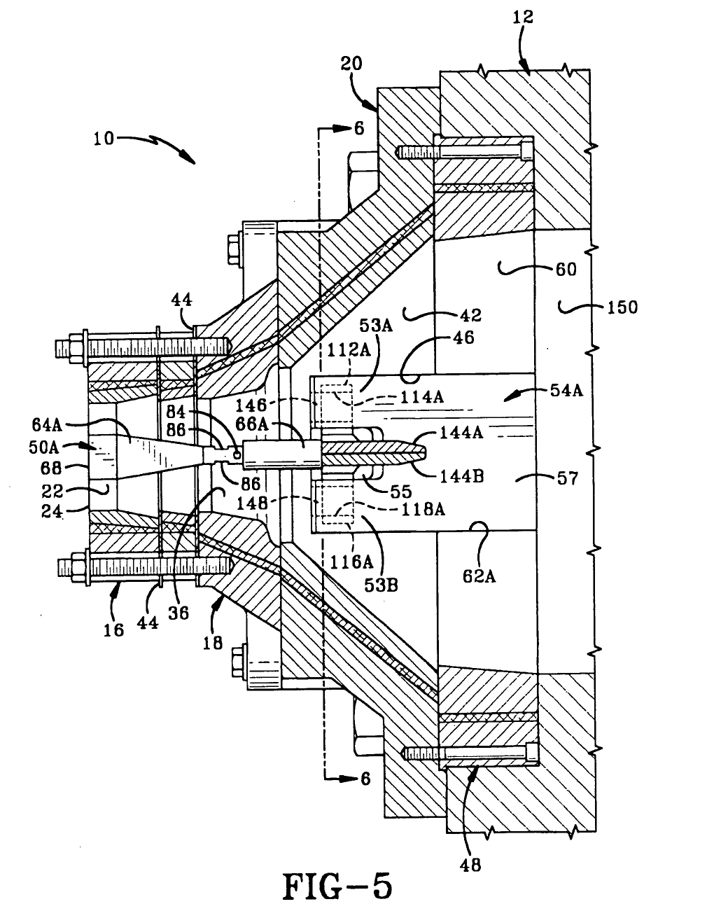

As shown in FIG. 4, upper triangular grooves 136 are formed in upper plate 106. Adjacent pairs of grooves 136 define upper ridges 138 therebetween. Likewise, lower triangular grooves 140 are formed in lower plate 108 with adjacent pairs of grooves 140 defining therebetween lower ridges 142. Upper grooves 136 and lower grooves 140 are offset from one another so that in general, upper ridges 138 are aligned with lower grooves 140 and lower ridges 142 are aligned with upper ridges 136 where applicable. These grooves are intended to provide additional surface area to each of the portions of material being extruded respectively above and below bridge 52 to facilitate their rejoining after moving past bridge 52. As shown in FIGS. 4 and 5, plates 106 and 108 have respective tapered or beveled edges 144A and 144B so that bridge 52 tapers inwardly in an upstream direction adjacent upstream end 126A-B. When assembled, ledges 98 of pipe 66 abut downstream ends 124A and B of plates 106 and 108.

Referring to FIG. 5, upper and lower mounting posts 146 and 148 are mounted on bridge ring 20 and extend in an upstream direction from adjacent a downstream end of a respective channel 46 of section 42 of the extrusion passage of die assembly 10. Posts 146 are received respectively within holes 114A and 114B of upper mounts 112 and posts 148 are received respectively with holes 118A and 118B of lower mounts 116 whereby bridge 52 is mounted on bridge ring 20 within and extending across passage section 42 thereof. FIG. 5 also shows bridge end filler member 54A positioned within channels 46 and 62A with upper and lower fingers 53A and 53B positioned respectively above and below a portion of bridge 52 which is thus disposed within notch 55 thereof. Fingers 53A and B are positioned respectively inwardly of and adjacent upper and lower mounts 112A and 116A. FIG. 5 generally shows the relationship between die assembly 10 and its various parts when assembled and extruder housing 12. Thus, FIG. 5 shows the alignment of and communication of the passage sections 22, 36, 42 and 60, all of which are aligned with an extrusion passage 150 extending through extruder housing 12. FIG. 5 further shows that the downstream ends 68 of each hole generating assembly 50 is substantially aligned with the downstream end 24 of die 16. Each assembly 50 is cantilevered in the downstream direction from bridge 52 to adjacent end 24.

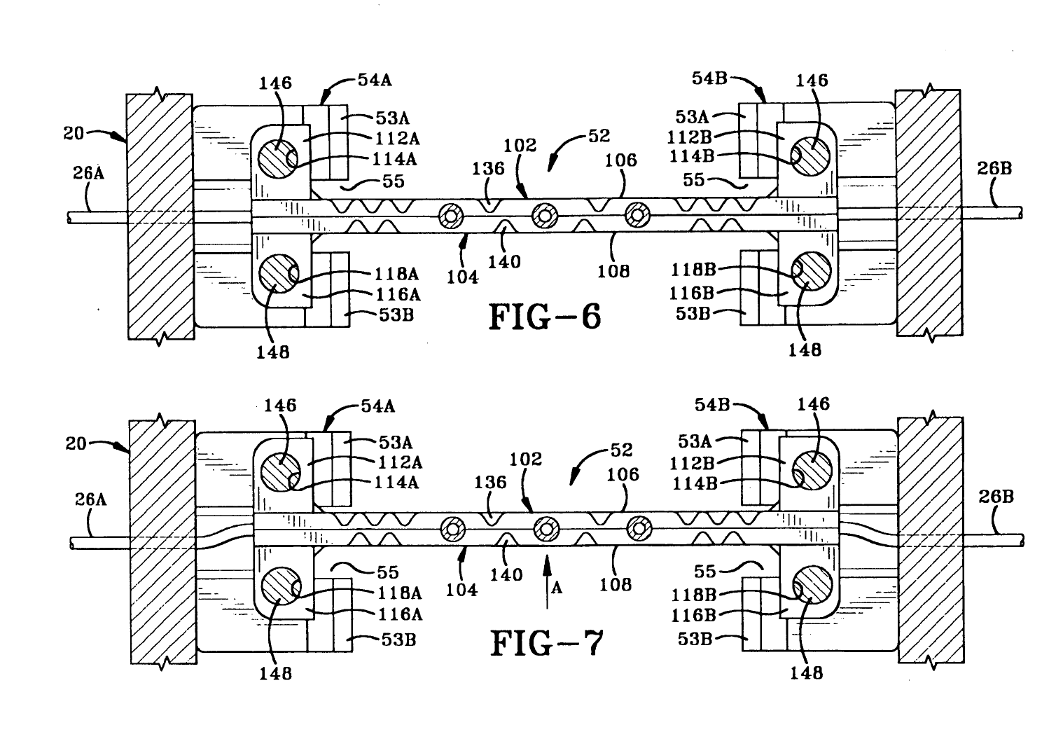

Posts 146 and 148 are moveably mounted on bridge ring 20 in particular to move up and down so that the position of bridge 52 may be adjusted within the extrusion passage. Thus, FIG. 6 shows bridge 52 in a first position and FIG. 7 shows bridge 52 in a second position having moved upwardly as indicated at Arrow A relative to the position shown in FIG. 6. Bridge 52 thus moves relative to bridge ring 20 and filler members 54 within the respective notches 55 thereof. The flexible nature of hoses 26 facilitates this movement of bridge 52 while continuing to provide the lubricating passage from source 28 (FIG. 1) to exit openings 84 (FIG. 5). FIG. 7 thus shows conduits 26A and B having flexed from the position in FIG. 6 to allow the movement of bridge 52.

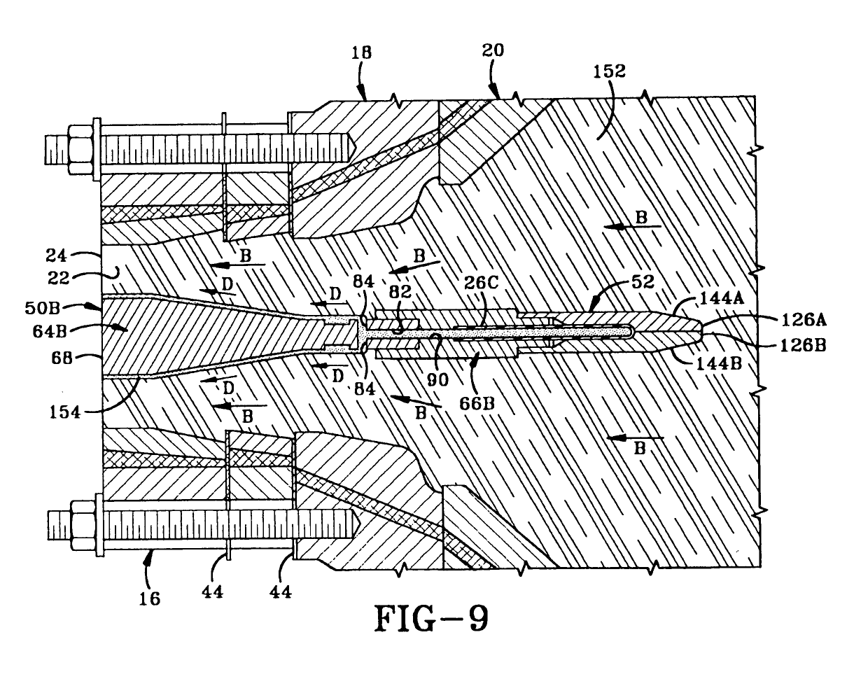

The operation of die assembly 10 is described primarily with reference to FIGS. 8 and 9. During the extrusion of green brick material 152 (FIG. 9) which is primarily formed of clay, the green brick material 152 moves through the various sections of the extrusion passage of the extruder and of die assembly 10 as indicated at Arrows B in FIG. 9. As material 152 is being extruded, the pressure from the extruder forces material 52 against the various inner surfaces bounding the extrusion passage and around the outer surfaces of bridge 52 and hole generating assemblies 50. Ordinarily, material 152 would be in direct contact with the outer surfaces of assemblies 50. However, a pump of source 28 (FIG. 1) pumps the lubrication fluid through conduits 26 into passages 90 and 82 and out of exit openings 84 in order to form a lubricating sheath 154 (FIG. 9) of the lubrication fluid which completely or substantially encases the outer surface of assemblies 50 downstream of exit openings 84. The flow of the lubrication fluid is shown generally at Arrows C in FIG. 8 and Arrows D in FIG. 9 to form sheath 154. The lubrication provided by the lubrication fluid substantially reduces the frictional engagement between material 152 and assemblies 50 to facilitate the formation of larger holes in the green brick material being extruded.

Ultimately, this material is fired to form brick 14 as shown in FIG. 10 in which the through openings or holes 156A-C are formed respectively by assemblies 50A-C. Thus, the diameter or cross-sectional distance D1 of each hole 156 may be substantially enlarged relative to those formed with prior art extrusion devices. Thus, webs 158 of brick 14 respectively between the holes 156 thereof may have a thickness represented by distance D2 which is substantially less than that of known prior art bricks. Likewise, webs 160 and 162 respectively between a hole 156 and either the side or end of brick 14 may have thicknesses as represented by distances D3 and D4 which are substantially less than that of known prior art bricks.

It will be appreciated by one skilled in the art that various changes may be made within the scope of the present invention. The key aspect of the invention is the ability to provide lubrication to the hole generating assemblies in order to reduce the friction between said assemblies and the extruding green brick material during formation of the green brick. While the exemplary embodiment of the present invention uses three hole-generating assemblies, it will be evident to one skilled in the art that any number of such assemblies may be used. It is fairly common to make bricks having 4 to 10 holes and thus use an analogous number of hole-generating assemblies. However, this number may be less than 3 or greater than 10 as well. As previously noted, conduits 26 are preferably formed of a flexible material to facilitate the adjustment of the bridge. This is especially true of the portion of conduits 26 extending from the bridge to the bridge ring. However, rigid conduits may also be used especially where adjustment of the bridge is not an issue. Furthermore, passages may be formed in the bridge by drilling holes therein instead of forming grooves as previously described.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus for use in generating a hole in extruded green brick material during extrusion thereof, the apparatus comprising:
a hole-generating assembly for generating the hole in the extruded green brick material;
a downstream end on the assembly;
a first lubricant through passage formed in the assembly adapted for moving a lubricant therethrough; and
an exit opening of the lubricant passage on the assembly upstream of its downstream end.

2. The apparatus of claim 1 further comprising first and second sections on the hole-generating assembly; and a downstream end on the first section; and wherein the second section is connected to the downstream end of the first section and has a cross sectional dimension smaller than that of the first section; and the exit opening is formed on the second section adjacent the downstream end of the first section.

3. The apparatus of claim 1 further comprising a head; and an outermost surface of the hole-generating assembly on the head for defining the hole in the brick material; and wherein the exit opening is upstream of the outermost surface.

4. The apparatus of claim 3 further comprising a tapered section on the hole-generating assembly which is upstream of the head and tapers inwardly in an upstream direction; and wherein the exit opening is upstream of the tapered section.

5. The apparatus of claim 1 further comprising a conduit in fluid communication with the first lubricant passage.

6. The apparatus of claim 5 further comprising an extrusion passage; and wherein the hole-generating assembly and conduit are in the extrusion passage.

7. The apparatus of claim 6 further comprising an annular wall circumscribing the extrusion passage; and wherein the conduit is connected to the annular wall.

8. The apparatus of claim 7 further comprising a hole formed through the annular wall; and wherein the conduit extends through the hole.

9. The apparatus of claim 1 further comprising an extrusion passage in which the hole-generating assembly is disposed; and a source of lubrication fluid outside the extrusion passage in fluid communication with the first lubricant passage.

10. The apparatus of claim 1 further comprising a bridge; and wherein the hole-generating assembly extends downstream from the bridge.

11. The apparatus of claim 10 further comprising a second lubricant through passage formed in the bridge in communication with the first passage.

12. The apparatus of claim 11 further comprising a receiving through passage formed in the bridge; and a conduit disposed in the receiving passage and defining the second lubricant passage.

13. The apparatus of claim 12 wherein the conduit is formed of a flexible material.

14. The apparatus of claim 11 further comprising a conduit extending outwardly from the bridge in fluid communication with second passage.

15. The apparatus of claim 14 further comprising a bridge ring; and an extrusion passage formed through the bridge ring; and wherein the bridge is mounted on the bridge ring and extends across the extrusion passage; and the conduit extends from the bridge to the bridge ring.

16. The apparatus of claim 15 wherein the bridge is selectively movable relative to the bridge ring to a plurality of positions within the extrusion passage; and the conduit is formed of a flexible material.

17. The apparatus of claim 14 further comprising a bridge end filler member adjacent the bridge and upstream of the conduit.

18. The apparatus of claim 1 further comprising a source of lubrication fluid in fluid communication with the first lubricant passage; and a pump for pumping the lubrication fluid from the source to the exit opening.

19. An apparatus for use in generating a hole in extruded green brick material during extrusion thereof, the apparatus comprising:
a bridge ring;
an extrusion passage formed through the bridge ring;
a bridge mounted on the bridge ring and extending across the passage;
a hole-generating assembly mounted on the bridge and extending downstream therefrom for generating the hole in the extruded green brick material; and
a lubricant conduit extending from the bridge ring to the bridge.

20. A method comprising the steps of:
extruding green brick material through an extrusion passage;
forcing the green brick material around a hole-generating member disposed in the passage; and
moving a lubrication fluid between the hole-generating member and the green brick material to reduce friction therebetween.
